(19) United States
(12) Patent Application Publication
(10) Pub. No.: US 2009/0100097 A1
(43) Pub. Date: Apr. 16, 2009

(54) AUDIO VIDEO ADVERTISEMENT METHOD

(76) Inventor: Fu-Sheng CHIU, Taipei city (TW)

Correspondence Address: SINORICA, LLC, 528 FALLSGROVE DRIVE, ROCKVILLE, MD, 20850, US

(21) Appl. No.: 12/115,811

(22) Filed: May 6, 2008

(30) Foreign Application Priority Data
Oct. 15, 2007 (TW) 96138424

(51) Int. Cl. G06F 17/30

(52) U.S. Cl. 707/104.1; 707/E17.009

(57) ABSTRACT

The present invention discloses an audio video advertisement method, which comprises steps: inputting at least one keyword into a webpage of a network platform; at least one company providing audio video files, giving each audio video file a company link, the network platform sorting out a plurality of the company links related to the keyword and listing the company links related to the keyword on the webpage; a frame opening in the webpage when a user clicks on one company link, and the network platform playing the audio video file provided by the company in the frame. For companies, the present invention can provide a new type of AV advertisement method. For users, an AV advertisement is more vivid and impressive than a conventional advertisement. Eliminating opening a new window for an AV file can also increase the users' desire to watch the advertisement.

### BACKGROUND OF THE INVENTION

1. Field of the Invention

The present invention relates to an AV website, particularly to an AV advertisement method.

2. Description of the Related Art

Internet search engines usually collect together various data and websites from the immensity of information on the Internet, work out the relationships thereof, and provide a list to users with a clear-at-a-glance information map.

At present, what a search engine returns is usually links to websites. Via the links, a user can access the webpages having the keywords the user inputs into the search engine. Generally, the search engine will attach a brief description to each link to help the user determine whether a link is the one he needs. However, a search engine can neither divide the links into text links and video links nor provide both of them at the same time. In other words, the website links a search engine provides do not directly link to video files. Some websites storing AV files provide the service for searching videos. However, such a service cannot extend to other websites but is only available in the special website.

Most websites display advertisements of sponsor companies. When a user clicks on one advertisement, the website of the sponsor will pop up. However, a user is likely to be disoriented and go astray in browsing a website he has never entered before. If clicking on one advertisement can directly start a self introduction of the company, users will be able to more easily understand the culture and related information of the company, which will benefit the marketing of the company.

Accordingly, the present invention proposes an audio video advertisement method to overcome the abovementioned problems.

### SUMMARY OF THE INVENTION

An objective of the present invention is to provide an audio video advertisement method, wherein a user inputs keywords into a network platform to obtain the links of the related companies, and wherein the user can instantly watch the audio video advertisement provided by the company as soon as the user clicks on the corresponding link.

Another objective of the present invention is to provide an audio video advertisement method, which lists the related links when a user performs a keyword search, ands which adopts an audio video link technology, wherein the audio video file provided by the corresponding company will be directly played in the original window without a new window popping up when the user clicks on one link.

Still another objective of the present invention is to provide an audio video advertisement method, which integrates a search engine technology with an audio video playing technology in a network platform, and which plays the audio video advertisements after the related companies have been obtained with a keyword search.

A further objective of the present invention is to provide an audio video advertisement method, which outperforms the introduction texts about the companies or the webpage links to the companies via directly playing the audio video files of the companies, and which can thus increase the marketing opportunity of the companies.

To achieve the abovementioned objectives, the present invention proposes an audio video (AV) advertisement method, which comprises the following steps: inputting at least one keyword into a webpage of a network platform; at least one company providing an audio video file having a link, sorting out a plurality of company links related to the keyword, and listing the company links on the webpage; and clicking on one company link to read the audio video file provided by the company, opening a frame in the webpage, and playing the audio video file in the frame.

Below, the embodiments will be described in detail to make easily understood the objectives, technical contents, characteristics and accomplishments of the present invention.

### BRIEF DESCRIPTION OF THE DRAWINGS

FIG. 1 is a block diagram schematically showing an AV advertisement method according to the present invention;

FIG. 2 is a flowchart of an AV advertisement method according to the present invention;

FIG. 3 to FIG. 5 are diagrams schematically showing an embodiment of an AV advertisement method according to the present invention; and

FIG. 6 and FIG. 7 are diagrams schematically showing another embodiment of an AV advertisement method according to the present invention.

### DETAILED DESCRIPTION OF THE INVENTION

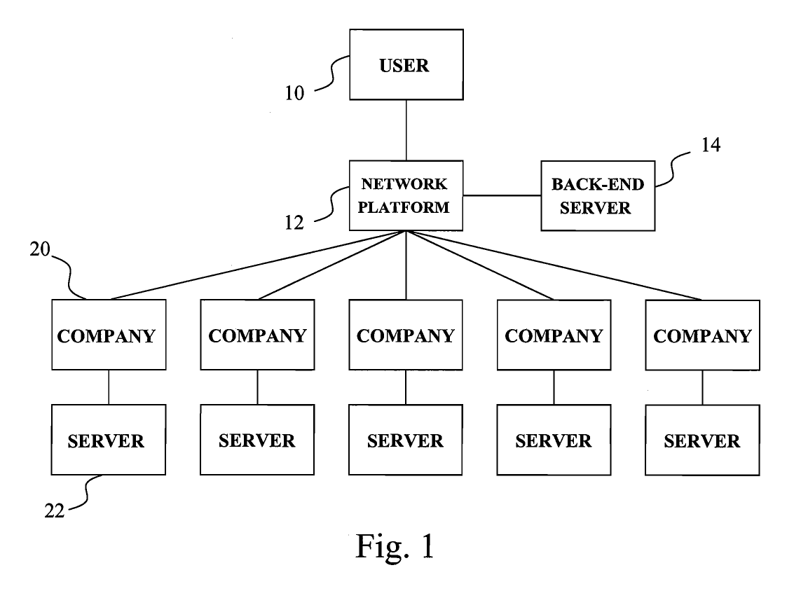

The present invention proposes an audio video (AV) advertisement method, which applies to the architecture shown in FIG. 1. The architecture shown in FIG. 1 includes: at least one user 10, a network platform 12, a back-end server 14 of the network platform 12, a plurality of companies 20 and a plurality of servers 22 of the companies 20.

Each company 20 provides an AV file, and the AV file is stored in the server 22 of the company 20 or in the back-end server 14 of the network platform 12. Each AV file has a link directing to a site where the AV file is stored—the server 22 or back-end server 14.

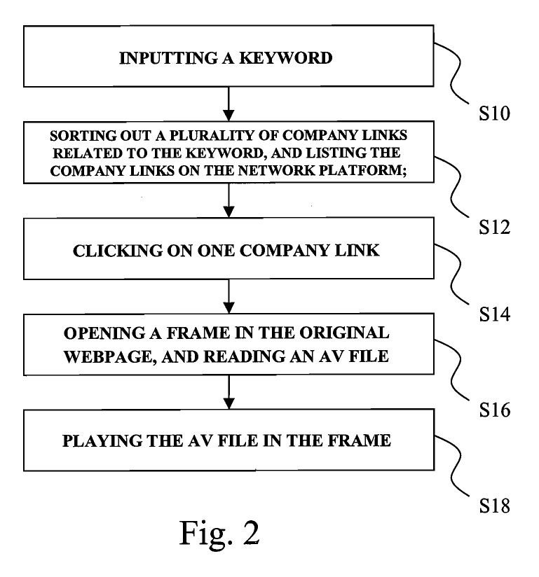

Refer to FIG. 2 for a flowchart of a method according to the present invention. In Step S10, keywords are input into a webpage of a network platform; the network platform may collate and list common keywords, and a user can perform a search via directly clicking on one of the listed keywords. In Step S12, the results containing the keyword are listed on the webpage in a form of links. In Step S14, the user clicks on one link. In Step S16, a frame opens in the original webpage and reads the AV file directed to by the link from a server; if the AV file is stored in a back-end server of the network platform, the AV file is read from the back-end server; if the AV file is stored in a server of a company, the AV file is downloaded from the server of the company via the network platform. In Step S18, the retrieved AV file is played in the frame with an AV playing program.

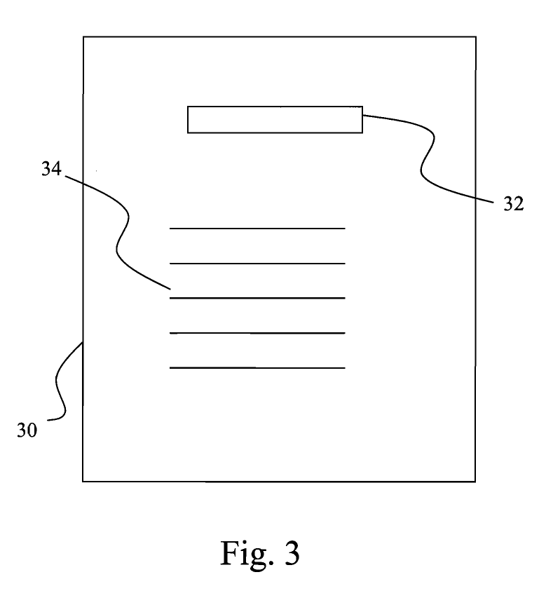

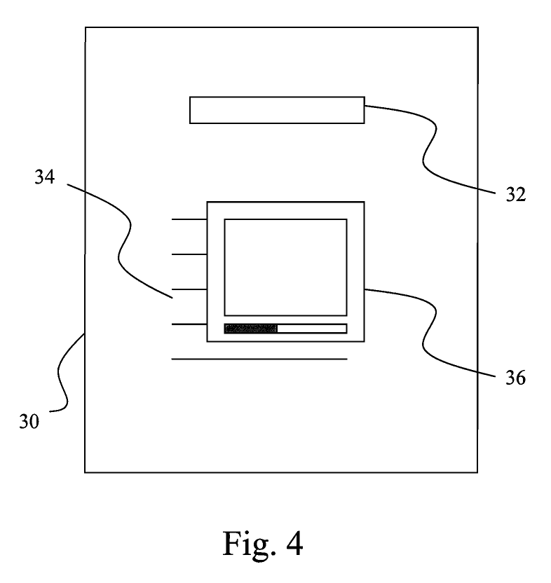

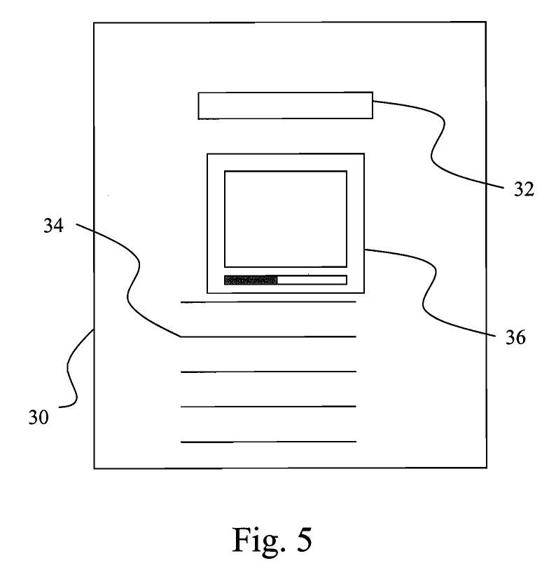

Refer to from FIG. 3 to FIG. 5 for an embodiment of the present invention. In FIG. 3, a user inputs a keyword into a field 32 on a webpage 30, and search results 34 are then listed on the original webpage 30. When the use clicks on a link contained in one search result, a frame 36 will open, as shown in FIG. 4 and FIG. 5. In FIG. 4, the frame 36 is a floating one, and the user can drag the frame 36 to move its position. In FIG. 5, the frame 36 is a static one, wherein the frame 36 is pulled down from the search result 34.

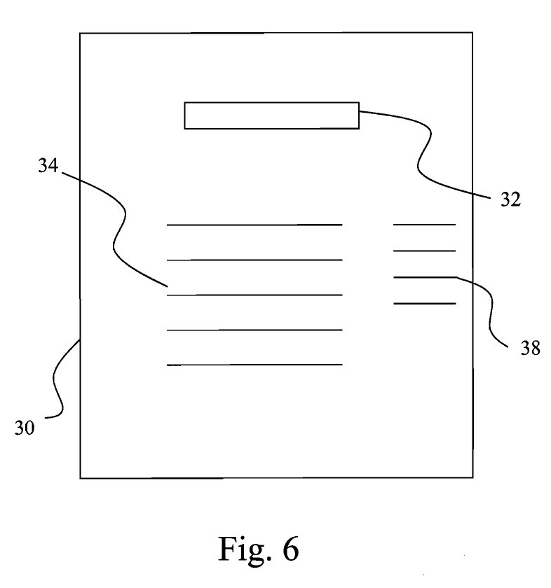

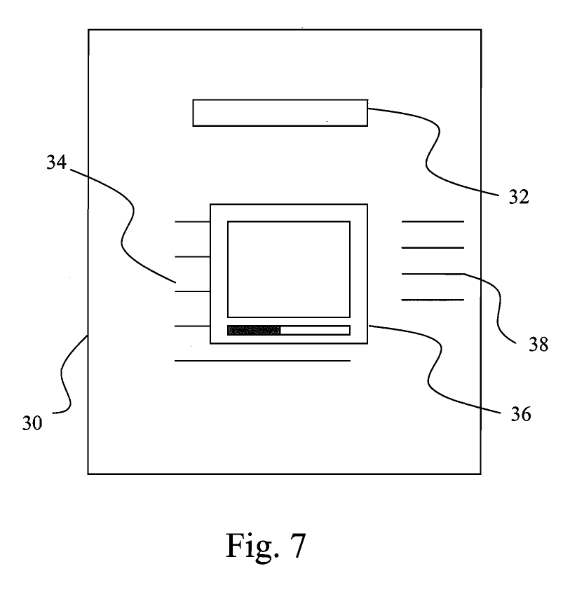

Refer to FIG. 6 and FIG. 7 for another embodiment of the present invention. A user inputs a keyword into a field 32 on a webpage 30, and search results 34 are then listed on the original webpage 30. The search results are basically similar to the website links obtained by a common search engine. In this embodiment, company links 38 to the companies providing AV files and related with the keyword are also listed on the webpage 30 particularly. When the user clicks on one company link 38, a frame 36 opens, and the AV file of the company will be played in the frame 36, as shown in FIG. 7. Thus, the companies can use AV files to advertise for their products.

In the present invention, when a frame opens in webpage of a network platform to download an AV file, neither a new window is opened nor the original webpage is totally rearranged, but only a portion of the original webpage is rearranged.

In conclusion, the present invention proposes an AV advertisement method, wherein a search engine technology and an AV playing technology are integrated in a network platform, and wherein after one keyword-related website link has been clicked on, an AV file can be downloaded from the back-end server of the network platform or the server of a company and then played on the original webpage of the network platform. Either a company or an individual person can utilize the present invention to undertake an AV advertisement in addition to common advertisement ways. For users, an AV advertisement is more vivid and impressive than a conventional advertisement. Besides, the mode that it is unnecessary to open a new window for an AV file can also increase the users' desire to watch the advertisement. Therefore, the present invention is not only novel but also useful.

The preferred embodiments described above are only to exemplify the present invention but not to limit the scope of the present invention. Any equivalent modification or variation according to the characteristics or spirit of the present invention is to be also included within the scope of the present invention.

What is claimed is:

1. An audio video advertisement method comprising steps:
inputting at least one keyword into a webpage of a network platform;
sorting out a plurality of links related to said at least one keyword, and listing said plurality of links on said webpage; and
clicking on one link of said plurality of links to read an audio video file, opening a frame in said webpage, and playing said audio video file in said frame.

2. The audio video advertisement method according to claim 1, wherein said audio video file is stored in a back-end server of said network platform.

3. The audio video advertisement method according to claim 1, wherein said audio video file is provided by a company, and said network platform reads said audio video file from a server of said company, and said audio video file is played on said network platform.

4. The audio video advertisement method according to claim 1, wherein after said at least one keyword is input into said network platform, said network platform sorts out at least one company link; after said company link is clicked on, said audio video file is played in said frame.

5. The audio video advertisement method according to claim 1, wherein said links are a plurality of company links related to said at least one keyword, and said company links direct to a plurality of company websites.

6. The audio video advertisement method according to claim 1, wherein said frame floats on said webpage.

7. The audio video advertisement method according to claim 1, wherein when said frame appears, original content of said webpage is pulled down to form a space for said frame.

8. The audio video advertisement method according to claim 1, wherein said audio video file is an advertisement of a company.

9. The audio video advertisement method according to claim 1, wherein said network platform collates and lists common keywords to convenience users directly clicking on one of said common keywords.

10. The audio video advertisement method according to claim 1, wherein when said network platform plays said audio video file, only a portion of said webpage is rearranged.

11. An audio video advertisement method comprising steps:
inputting at least one keyword into a webpage of a network platform;
at least one company providing audio video files, giving each said audio video file a company link, sorting out a plurality of said company links related to said at least one keyword and listing said company links related to said keyword on said webpage; and
clicking on one said company link to read one said audio video file provided by one said company, opening a frame in said webpage, and playing said audio video file in said frame.

12. The audio video advertisement method according to claim 11, wherein said audio video file is stored in a back-end server of said network platform, and said company link directs to said back-end server.

13. The audio video advertisement method according to claim 11, wherein said audio video file is stored in a server of said company, and said company link directs to said server for reading said audio video file.

14. The audio video advertisement method according to claim 11, wherein after said at least one keyword is input into said network platform, said network platform simultaneously lists a plurality of information links related to said keyword and a plurality of said company links related to said keyword.

15. The audio video advertisement method according to claim 11, wherein said frame floats on said webpage.

16. The audio video advertisement method according to claim 11, wherein when said frame appears, original content of said webpage is pulled down to form a space for said frame.

17. The audio video advertisement method according to claim 11, wherein said audio video file is an advertisement of one said company.

18. The audio video advertisement method according to claim 11, wherein said network platform collates and lists common keywords to convenience users directly clicking on one of said common keywords.

19. The audio video advertisement method according to claim 11, wherein when said network platform plays said audio video file, only a portion of said webpage is rearranged.
